(19) United States
(12) Patent Application Publication
(10) Pub. No.: US 2013/0031632 A1
(43) Pub. Date: Jan. 31, 2013

(54) System and Method for Detecting Malicious Content

(71) Applicants: Stephen Thomas, Marietta, GA (US); Christopher Stevens, Atlanta, GA (US)

(72) Inventors: Stephen Thomas, Marietta, GA (US); Christopher Stevens, Atlanta, GA (US)

(73) Assignee: DELL PRODUCTS, LP, Round Rock, TX (US)

(21) Appl. No.: 13/193,063

(22) Filed: Jul. 28, 2011

(51) Int. Cl. G06F 11/00; G06F 21/00

(52) U.S. Cl. 726/23

(57) ABSTRACT

An intrusion prevention system receives a file, determines that the file does not correspond to an entry of a database, sends a request associated with the file to an intrusion prevention server responsive to determining that the file does not correspond to the entry, receives a reply from the intrusion prevention server, and provides an indication to a client system that the file includes the exploit responsive to the reply.

### FIELD OF THE DISCLOSURE

The present disclosure generally relates to information handling systems, and more particularly relates to detecting malicious content in an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, and networking systems. Information handlings systems can also implement various virtualized architectures.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an intrusion prevention network according to an embodiment of the present disclosure;

FIG. 2 is a block diagram illustrating loading an exploit database from an intrusion prevention server to an intrusion prevention system in the intrusion prevention network of FIG. 1, according to an embodiment of the present disclosure;

FIG. 3 is a block diagram illustrating handling potentially malicious information in the intrusion prevention network of FIG. 1, according to an embodiment of the present disclosure;

FIG. 4 is a block diagram illustrating loading potentially malicious information from the intrusion prevention system to the intrusion prevention server in the intrusion prevention network of FIG. 1, according to an embodiment of the present disclosure;

FIG. 5 is a block diagram illustrating sharing of an exploit database in the intrusion prevention network of FIG. 1, according to an embodiment of the present disclosure;

FIG. 6 is a flowchart illustrating a method of detecting malicious content in an intrusion prevention network, according to an embodiment of the present disclosure;

FIG. 7 is a flowchart illustrating a method of propagating exploit database information in the intrusion prevention network of FIG. 1, according to an embodiment of the present disclosure; and

FIG. 8 is a block diagram illustrating an information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings. Other teachings can be used in this application, and the teachings can be used in other applications and with different types of architectures, such as a client-server architecture, a distributed computing architecture, or a middleware server architecture and associated resources.

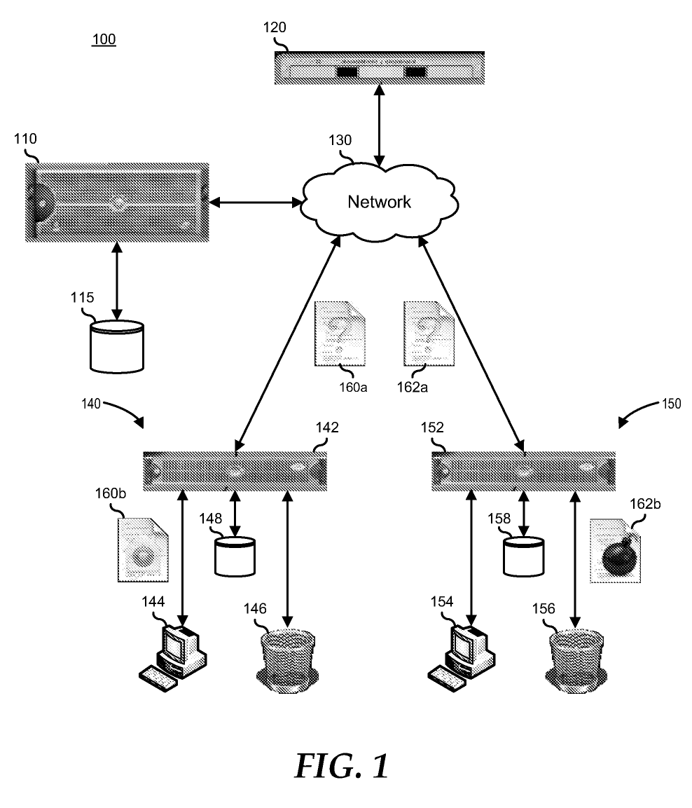

FIG. 1 illustrates an embodiment of an intrusion prevention network 100 that can include one or more information handling systems. For purposes of this disclosure, the information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic, and operates to execute code. Additional components of the information handling system may include one or more storage devices that can store code, one or more communications ports for communicating with external devices as well as various input and output (I/O) devices, such as a keyboard, a mouse, and a video display. The information handling system may also include one or more buses operable to transmit communications between the various hardware components.

In a particular embodiment, intrusion prevention network 100 includes an intrusion prevention server 110, an internet server 120, a network 130, an intrusion prevention client network 140, and one or more additional intrusion prevention client networks 150. Intrusion prevention server 110 includes a global exploit database 115. Intrusion prevention client network 140 includes an intrusion prevention system 142, one or more client systems 144, trash file 146, and a local exploit database 148. Intrusion prevention client network 150 includes an intrusion prevention system 152, one or more client systems 154, a trash file 156, and a local exploit database 158.

In operation, client systems 144 and 154 request information from internet server 120, and internet server 120 sends the requested information to the requesting client system 144 or 154. For example, client system 144 can request information 160a from internet server 120, and client system 154 can request information 162a from internet server 120. Information 160a is received by intrusion prevention system 142, and the intrusion prevention system analyzes the contents of the information to determine if the information is safe, or if the information includes possibly malicious information. If the information is determined to be safe, then intrusion prevention system 142 forwards the information as safe information 160b to client system 144, as requested. Similarly, information 162a is received by intrusion prevention system 152, and the intrusion prevention system analyzes the contents of the information to determine if the information is safe or if it includes possibly malicious information. If the information is determined to include malicious information, intrusion prevention system 152 forwards the information as malicious information 162b to trash file 156, thereby preventing client system 154 from receiving the malicious information. In a particular embodiment, intrusion prevention systems 142 and 152 do not include trash files 146 and 156, respectively. Instead, if the information is determined to include malicious information, then intrusion prevention system 152 drops the malicious information 162b in order to prevent client system 154 from receiving the malicious information.

Malicious information includes machine-executable code that operates to exploit client systems 144 and 154, to damage the client systems, or otherwise misuse the computing resources of the client systems. Malicious information includes various exploits and threats, such as viruses, worms, malicious software (malware), advertising software (adware), spy software (spyware), Trojans, other exploits, or a combination thereof. The specific nature and forms of malicious information are well known and described in the art and will not be further discussed herein, except as needed for illustrative purposes. As used herein, the term “exploit” shall be deemed to include the various types of malicious information, and that are identifiable as compared to other instances of malicious information.

In a particular embodiment, intrusion prevention systems 142 and 152 operate to analyze information flows. As such, intrusion prevention systems 142 and 152 recognize multiple data types, file types, object types, and other structures within the information, and analyze the individual structures to determine if the contents of the structures include known exploits. In particular, many types of data, files, objects, and other structures can be used to carry viruses, worms, malware, adware, spyware, Trojans, or other exploits. For example, common ways to deliver exploits can include Microsoft Office™ documents such as Word™, Excel™, and Powerpoint™ documents, Adobe™ Portable Document Format (PDF) documents, hypertext markup language (HTML) documents, Java™ objects, Multipurpose Internet Mail Extensions (MIME) objects, and other types of data, files, objects, and structures. The specific nature and forms of data, files, objects, and other structures that can include exploits are well known and described in the art and will not be further discussed herein, except as needed for illustrative purposes. In a particular embodiment, intrusion prevention systems 142 and 152 operate to analyze structures that are nested within other structures of the information. For example, intrusion prevention system 142 can analyze a Word™ document, and can also analyze a Java™ object embedded within the Word™ document. In general, intrusion prevention systems 142 and 152 analyze information flows by generating a hash of the flow as it is being received. When a particular portion of the information is fully received by intrusion prevention systems 142 or 152, the generated hash is compared against the contents of local exploit databases 148 and 158, respectively, to determine if the information is known to include an exploit or is known to be safe, or to determine that it is unknown if the information includes an exploit or is safe. As used herein, the term “file” shall be deemed to include the various data types, file types, object types, and other structures within a flow of information, and that are identifiable as compared to other structures within the flow of information.

In a particular embodiment, intrusion prevention server 110 and intrusion prevention systems 142 and 152 operate to exchange database entries related to various known exploits and known safe files, to detect new potential exploits, to determine if the potential exploits are in fact malicious, and to propagate identifying database entries related to the new exploits to the intrusion prevention systems. As such, global exploit database 115 includes a database entry that is associated with each known exploit and a database entry that is associated with each known safe file. In a particular embodiment, local exploit databases 148 and 158 include copies of the database entries included in global exploit database 115. In another embodiment, local exploit databases 148 and 158 include subsets of the database entries included in global exploit database 115. Here, various heuristic methods can be utilized to ensure that local exploit databases 148 and 158 include entries for the most commonly detected exploits, while the global exploit database can be relied upon for detection of less commonly detected exploits. In this way, the performance of intrusion prevention systems 142 and 152 can be optimized for storage capacity, database access time, information throughput, processing capacity, or other data processing metrics, as needed or desired.

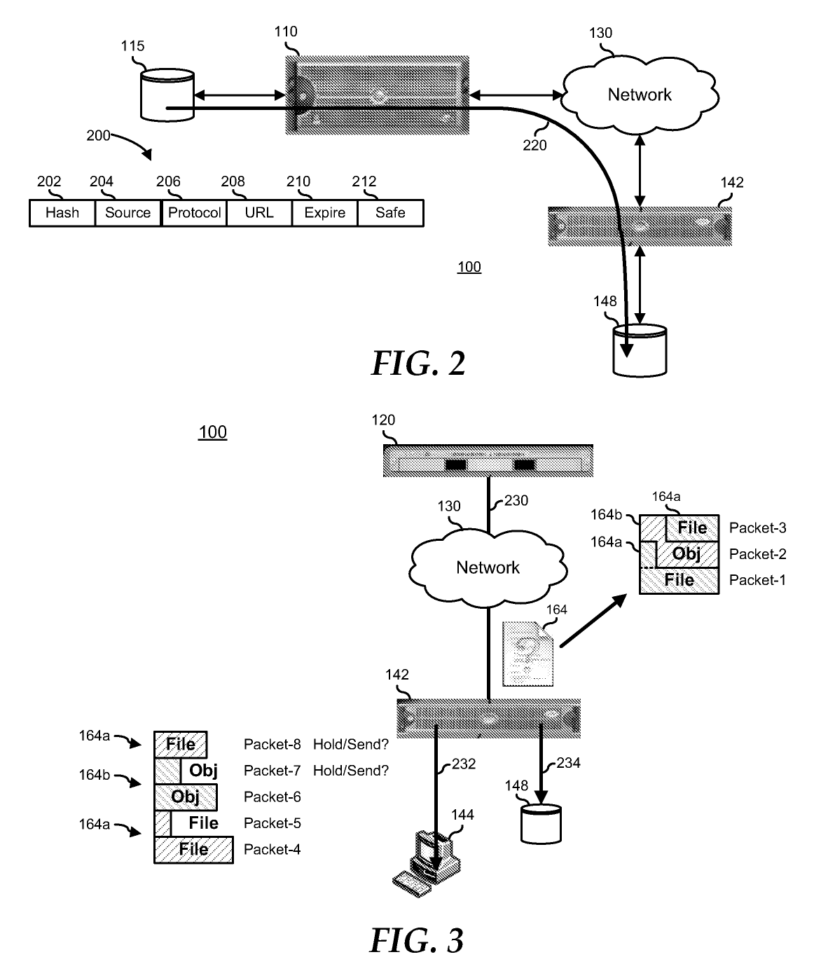

FIG. 2 illustrates an example of loading a database entry 200 from global exploit database 115 to local exploit database 148. Database entry 200 includes a hash field 202, a source field 204, a protocol field 206, a universal resource locator (URL) field 208, an expiration field 210, and a safe field 212. Hash field 202 includes a hash derived from an exploit file, or from a known safe file, and that uniquely identifies the contents of the associated file. The contents of hash field 202 can be derived using a particular hash algorithm, such as a message-digest algorithm hash like MD5 or MD6, a secure hash algorithm hash like SHA-2 or SHA-3, or another hash algorithm, as needed or desired. Source field 204 includes information as to a particular source internet protocol (IP) address associated with the file, and protocol field 206 includes information as to a transport protocol associated with the file. URL field 208 includes information as to a URL from which the file has been delivered, and may include more than one associated URL. Source field 204, protocol field 206, and URL field 208 can be used to improve the performance of intrusion protection systems 142 and 152, for example, where one or more URLs are typically associated with malicious information. Expiration field 210 includes an optional expiration time or date for database entry 200. Safe field 212 includes a flag that identifies database entry 200 as being associated with a file that includes an exploit, or with a file that is safe. Intrusion prevention server 110 provides database entry 200 from global exploit database 115 to local exploit database 148 as illustrated in step 220.

FIG. 3 illustrates an example of handling potentially malicious information 164 in intrusion prevention network 100. Client system 144 requests information 164 from internet server 120. Information 164 is sent from internet server 120 to intrusion prevention system 142 as illustrated in step 230. Information 164 includes a file 164a and an embedded object 164b, and is sent from internet server 120 in data packets. As such, file 164a is sent in packet-1, a portion of packet-2, and a portion of packet-3, and object 164b is sent in a portion of packet-2 and a portion of packet-3.

When intrusion prevention system 142 receives packet-1, the intrusion prevention system determines that the packet includes a beginning portion of file 164a, and begins to generate a hash for file 164a. Also, although it is yet unknown whether file 164a includes an exploit, intrusion prevention system 142 sends the beginning portion of file 164a in packet-4 to client system 144 in step 232. When intrusion prevention system 142 receives packet-2, the intrusion prevention system determines that the packet includes a continuing portion of file 164a and a beginning portion of object 164b. Intrusion prevention system 142 continues generating the hash for file 164a, begins to generate a hash for object 164b, and sends the continuing portion of file 164a in packet-5 and the beginning portion of object 164a in packet-6 to client system 144. In a particular embodiment, the continuing portion of file 164a and the beginning portion of object 164a are sent to client system 144 in one packet.

When intrusion prevention system 142 receives packet-3, the intrusion prevention system determines that the packet includes an ending portion of object 164b and an ending portion of file 164a. Intrusion prevention system 142 finishes generating the hashes for object 164b and for file 164a. When the hash is fully generated for object 164b, intrusion prevention system 142 compares the hash with the database entries in local exploit database 148 to determine if object 164b includes an exploit or is safe to deliver to client system 144 in step 234. If the hash matches a known exploit in local exploit database 148, then the ending portion of object 164b is dropped or sent to trash file 146. If the hash matches a known safe file in local exploit database 148, then the ending portion of object 164b is sent to client system 144 in packet-7. In a particular embodiment, if the hash does not match either a known exploit or a known safe file in local exploit database 148, intrusion prevention system 142 sends the ending portion of object 164b in packet-7 to client system 144, and sends an indication to client system 144 that object 164b possibly includes an exploit. Similarly, when the hash is fully generated for file 164a, intrusion prevention system 142 compares the hashes with the database entries in local exploit database 148 to determine if file 164a includes an exploit or is safe to be delivered to client system 144. If the hash matches known exploits in local exploit database 148, then the ending portion of file 164a is dropped or sent to trash file 146. If the hash matches known safe files in local exploit database 148, then the ending portion of file 164a is sent to client system 144 in packet-8. Here too, if the hash does not match either a known exploit or a known safe file in local exploit database 148, intrusion prevention system 142 sends the ending portion of file 164a to client system 144 in packet-8, and sends an indication to client system 144 that file 164a possibly includes an exploit.

In a particular embodiment, intrusion prevention system 142 stores all of file 164a, and all of object 164b while the hashes are being generated, and does not send them to client system 144 until it is determined if they contain exploits or are safe. In this embodiment, the traffic between intrusion prevention system 142 and client system 144 is decreased, but at the expense of much greater storage capacity demand and processing demand on intrusion prevention system 142. In another embodiment, if any of the hashes for file 164a and object 164b do not match either a known exploit or a known safe file in local exploit database 148, intrusion prevention system 142 prevents the final portions of file 154a or object 164b from being sent to client system 144. However, since a large portion of information communicated on intrusion prevention network 100 is both unknown and safe, this embodiment may result in excessive blocking of data transmission on the intrusion prevention network.

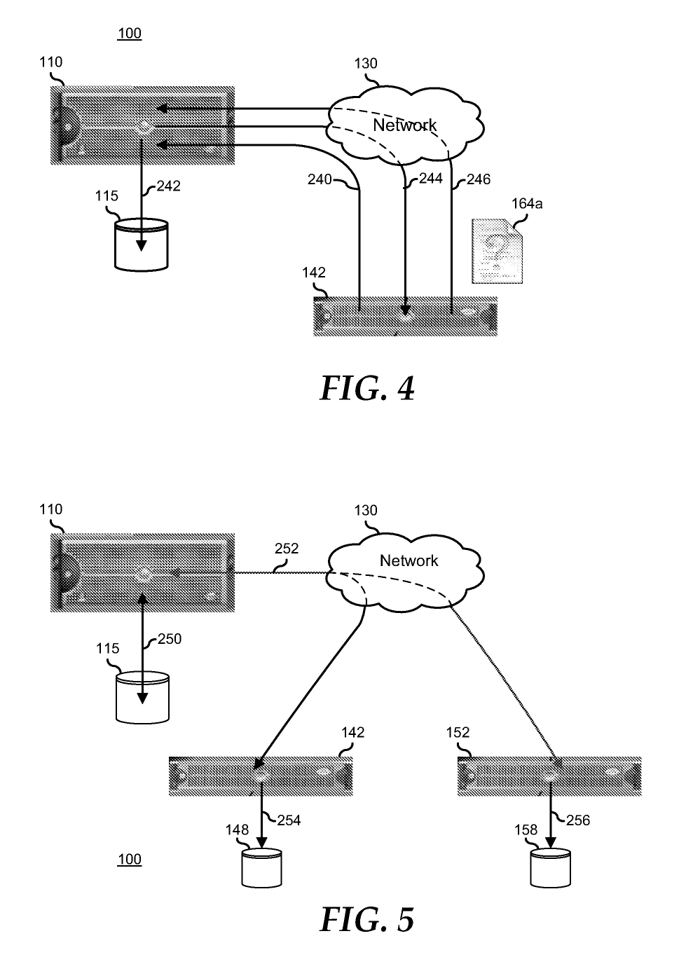

FIG. 4 illustrates an example of evaluating unknown files in intrusion prevention network 100. In a particular embodiment, if a hash for a received file does not match an entry for either a known exploit or a known safe file in local exploit database 148, intrusion prevention system 142 sends an indication to intrusion prevention server 110 in step 240, indicating that the intrusion prevention system has received an unknown file. In the embodiment where local exploit databases 148 and 158 include copies of the database entries included in global exploit database 115, the indication informs intrusion prevention server 110 of the unknown file, and the intrusion prevention server sends a request in step 244, requesting the unknown file from intrusion prevention system 142. Intrusion prevention system 142 responds by sending the unknown file, for example, file 164a, to intrusion prevention server 110 in step 246. In a particular embodiment, intrusion prevention system 142 retrieves all portions of the unknown file from client system 144. In another embodiment, intrusion prevention system 142 sends identifying information, such as a URL, that enables intrusion prevention server 110 to retrieve a fresh copy of the file from the source. When intrusion prevention server 110 has the unknown file, the unknown file is analyzed in depth to determine if the file includes an exploit, or is safe. Once the determination is made, the hash for the file is included in a database entry similar to database entry 200 and added to global exploit database 115 in step 242. The analysis of the unknown files in intrusion prevention server 110 can be performed in a variety of ways, including running the machine-executable code included in the file in an isolated system space such as a virtual operating system to determine if the file includes an exploit, comparing various markers in the file with known good or known bad markers, manually determining if the file includes an exploit, or other ways of analyzing unknown files, as needed or desired.

In the embodiment where local exploit databases 148 and 158 include subsets of the database entries included in global exploit database 115, intrusion prevention server 110 compares the hash received in step 240 with the database entries in global exploit database 115 to determine if the unknown file includes an exploit or is safe to deliver to client system 144 in step 242. If the hash matches a known exploit or a known safe file in global exploit database 115, then intrusion prevention server 110 sends an indication of the result in step 244, and intrusion prevention system 142 takes appropriate action, such as adding an entry for the file in local exploit database 115, and sending an indication to client system 144 that the file either includes an exploit, or is safe. If the hash does not match either a known exploit or a known safe file in global exploit database 115, intrusion prevention server 110 sends a request in step 244, requesting the unknown file from intrusion prevention system 142. Intrusion prevention system 142 responds by sending the unknown file, for example file 164a, to intrusion prevention server 110 for analysis in step 246.

FIG. 5 illustrates an example of sharing of entries between global exploit database 115 and local exploit databases 148 and 158. When intrusion prevention server 110 has analyzed an unknown file in depth to determine if the file includes an exploit, or is safe, the resulting database entry is provided to global exploit database 115 in step 250. The database entry is then shared across intrusion prevention network 100. In the embodiment where local exploit databases 148 and 158 include copies of the database entries included in global exploit database 115, the database entry is sent to intrusion prevention systems 142 and 152 in step 252, and the intrusion prevention systems store the database entry in local exploit database 148 in step 254 and in local exploit database 158 in step 256, respectively. In the embodiment where local exploit databases 148 and 158 include subsets of the database entries included in global exploit database 115, intrusion prevention server 110 can employ the various heuristic methods to determine which database entries are to be propagated to intrusion prevention systems 142 and 152. Then intrusion prevention server 110 shares the database entry to one, the other, or both of intrusion prevention systems 142 and 152 in step 252. If intrusion prevention system 142 received the database entry, then the intrusion prevention system stores the database entry in local exploit database 148 in step 254. If intrusion prevention system 152 received the database entry, then the intrusion prevention system stores the database entry in local exploit database 158 in step 256. In another embodiment, intrusion prevention systems 142 and 152 can employ the various heuristic methods to determine which entries are to be stored in local databases 148 and 158, respectively. Here, the database entry is sent to intrusion prevention systems 142 and 152 in step 252. Then intrusion prevention system 142 can determine which database entries are stored in local intrusion database 148 in step 254, and intrusion prevention system 152 can determine which database entries are stored in local intrusion database 158 in step 256.

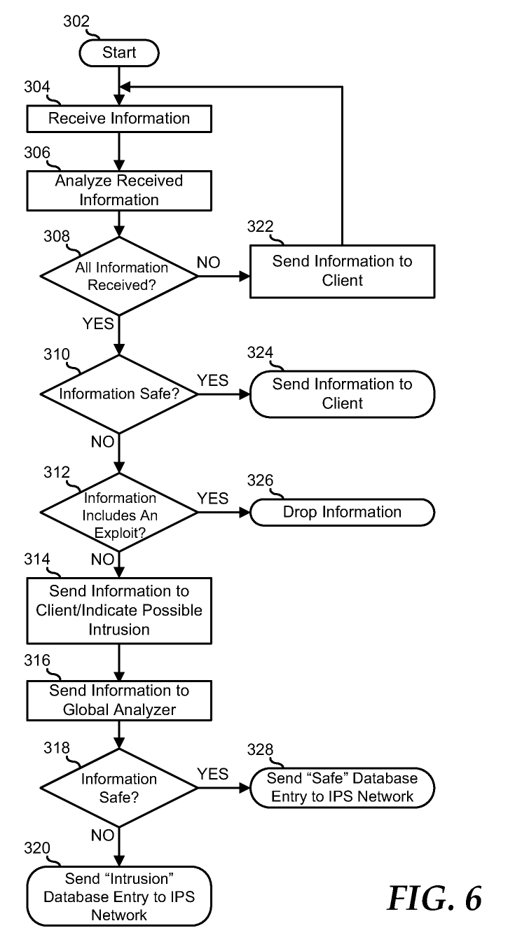

FIG. 6 illustrates a method of detecting malicious information in an intrusion prevention network. The method starts at block 302, and information is received by an intrusion prevention system in block 304. For example, intrusion prevention system 142 can receive a file that potentially includes an exploit. The information is analyzed by the intrusion prevention system in block 306. For example, intrusion prevention system 142 can begin to determine a hash for the received file. A decision is made as to whether or not all of the information is received in decision block 308. If not, the “NO” branch of decision block 308 is taken, the received information is forwarded to a client system in block 322, and processing returns to block 304 where additional information is received by the intrusion prevention system. Thus intrusion prevention system 142 can provide the received portions of the file to client system 144. If all of the information is received, the “YES” branch of decision block 308 is taken, and a decision is made as to whether or not the information is safe in decision block 310. For example, intrusion prevention system 142 can compare a hash of received file with the entries in local exploit database 148, or with the entries in global exploit database 115, to determine whether or not the file is safe, includes a known exploit, or is unknown. If the information is safe, the “YES” branch of decision block 310 is taken, and the final portion of the received information is forwarded to the client system in block 324, and the method ends.

If the information is not safe, the “NO” branch of decision block 310 is taken, and a decision is made as to whether or not the information includes a known exploit in decision block 312. If so, the “YES” branch of decision block 312 is taken, and the information is dropped in block 326. For example, intrusion prevention system 142 can send the last portion of file that includes a known exploit to trash file 146, or can drop the last portion of the file. If the information does not include a known exploit, the “NO” branch of decision block 312 is taken, and the last portion of the information is sent to the client system, along with an indication that the information potentially includes malicious information in block 314. For example, intrusion prevention system 142 can send the last portion of the file that potentially includes an exploit to client system 144, and can provide an indication to the client system that the file potentially includes an exploit. The information that potentially includes an exploit is sent to a global information analyzer in block 316. For example, intrusion prevention system 142 can provide files that potentially include an exploit to intrusion prevention server 110. A decision is made as to whether or not the information is safe in decision block 318. For example, intrusion prevention server 110 can compare the hash of received file with the entries in global exploit database 115, to determine whether or not the file is safe, or includes a known exploit. If the information is safe, the “YES” branch of decision block 318 is taken, and a database entry indicating that the information is safe is sent to the local exploit databases in an intrusion prevention network in block 328, and the method ends. If the information is not safe, the “NO” branch of decision block 318 is taken, a database entry indicating that the information includes an exploit is sent to the local exploit databases in an intrusion prevention network in block 320, and the method ends. For example, intrusion prevention server 110 can send database entries to local exploit databases 148 and 158.

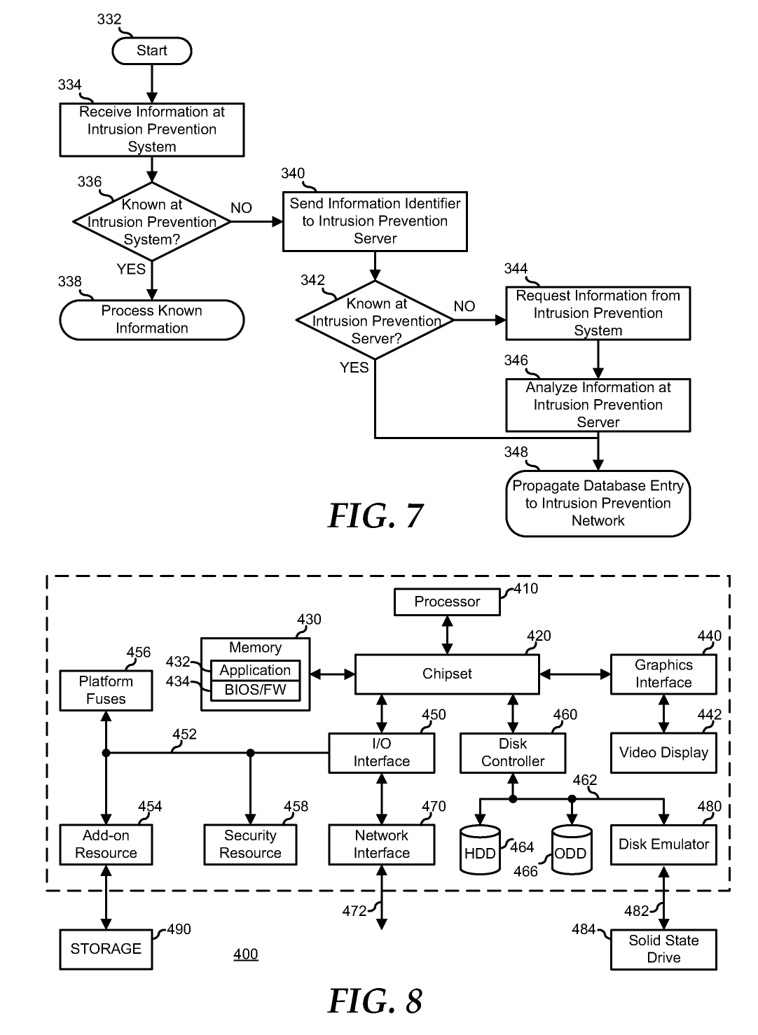

FIG. 7 illustrates a method of propagating exploit database information in an intrusion prevention network. The method starts at block 332, and information is received by an intrusion prevention system in block 334. For example, intrusion prevention system 142 can receive a file that potentially includes an exploit. A decision is made as to whether or not the information is known by the intrusion prevention system to include an exploit, or is known to be safe in decision block 336. If so, the “YES” branch of decision block 336 is taken, the known information is processed in block 338, and the method ends. For example, intrusion prevention system 142 can handle a file with a known exploit or that is known to be safe as described in the method illustrated in FIG. 6. If the intrusion prevention system is unable to determine if the information is known to include an exploit, or is known to be safe, the “NO” branch of decision block 336 is taken, and an identifier for the information is sent to an intrusion prevention server in block 340. For example, intrusion prevention system 142 can send a hash of the file, or other identifying information related to the file, to intrusion prevention server 110. A decision is made as to whether or not the information is known by the intrusion prevention server to include an exploit, or is known to be safe in decision block 342. If so, the “YES” branch of decision block 342 is taken, a database entry associated with the information is propagated to the intrusion prevention network in block 348, and the method ends. For example, intrusion prevention server 110 can send a database entry associated with the file to intrusion prevention systems 142 and 152 for storing in local exploit databases 148 and 158, respectively. If the intrusion prevention server is unable to determine if the information is known to include an exploit, or is known to be safe, the “NO” branch of decision block 342 is taken, and the intrusion prevention server requests the information from the intrusion prevention system in block 344. For example, intrusion prevention server 110 can request the file from intrusion prevention system 142. In a particular embodiment, intrusion prevention system 142 provides the file to intrusion prevention server 110. In another embodiment, intrusion prevention system 142 provides a file identifier, such as a URL for the file, to intrusion prevention server 110. The method continues in block 346 where the information is analyzed in the intrusion prevention server, to determine if the information includes an exploit, or is safe, and a database entry associated with the information is propagated to the intrusion prevention network in block 348, and the method ends. For example, intrusion prevention server 110 can create a database entry, store the data base entry in global exploit database 115, and sent the database entry to intrusion prevention systems 142 and 152.

FIG. 8 is a block diagram illustrating an embodiment of an information handling system 400, including a processor 410, a chipset 420, a memory 430, a graphics interface 440, an input/output (I/O) interface 450, a disk controller 460, a network interface 470, and a disk emulator 480. In a particular embodiment, information handling system 400 is used to carry out one or more of the methods described herein. In another embodiment, one or more of the systems described herein are implemented in the form of information handling system 400.

Chipset 420 is connected to and supports processor 410, allowing the processor to execute machine-executable code. In a particular embodiment (not illustrated), information handling system 400 includes one or more additional processors, and chipset 420 supports the multiple processors, allowing for simultaneous processing by each of the processors and permitting the exchange of information among the processors and the other elements of the information handling system. Chipset 420 can be connected to processor 410 via a unique channel, or via a bus that shares information among the processor, the chipset, and other elements of information handling system 400.

Memory 430 is connected to chipset 420. Memory 430 and chipset 420 can be connected via a unique channel, or via a bus that shares information among the chipset, the memory, and other elements of information handling system 400. In another embodiment (not illustrated), processor 410 is connected to memory 430 via a unique channel. In another embodiment (not illustrated), information handling system 400 includes separate memory dedicated to each of the one or more additional processors. A non-limiting example of memory 430 includes static random access memory (SRAM), dynamic random access memory (DRAM), non-volatile random access memory (NVRAM), read only memory (ROM), flash memory, another type of memory, or any combination thereof.

Graphics interface 440 is connected to chipset 420. Graphics interface 440 and chipset 420 can be connected via a unique channel, or via a bus that shares information among the chipset, the graphics interface, and other elements of information handling system 400. Graphics interface 440 is connected to a video display 442. Other graphics interfaces (not illustrated) can also be used in addition to graphics interface 440 as needed or desired. Video display 442 includes one or more types of video displays, such as a flat panel display, another type of display device, or any combination thereof.

I/O interface 450 is connected to chipset 420. I/O interface 450 and chipset 420 can be connected via a unique channel, or via a bus that shares information among the chipset, the I/O interface, and other elements of information handling system 400. Other I/O interfaces (not illustrated) can also be used in addition to I/O interface 450 as needed or desired. I/O interface 450 is connected via an I/O interface 452 to one or more add-on resources 454. Add-on resource 454 is connected to a storage system 490, and can also include another data storage system, a graphics interface, a network interface card (NIC), a sound/video processing card, another suitable add-on resource or any combination thereof. I/O interface 450 is also connected via I/O interface 452 to one or more platform fuses 456 and to a security resource 458. Platform fuses 456 function to set or modify the functionality of information handling system 400 in hardware. Security resource 458 provides a secure cryptographic functionality and includes secure storage of cryptographic keys. A non-limiting example of security resource 458 includes a Unified Security Hub (USH), a Trusted Platform Module (TPM), a General Purpose Encryption (GPE) engine, another security resource, or a combination thereof.

Disk controller 460 is connected to chipset 420. Disk controller 460 and chipset 420 can be connected via a unique channel, or via a bus that shares information among the chipset, the disk controller, and other elements of information handling system 400. Other disk controllers (not illustrated) can also be used in addition to disk controller 460 as needed or desired. Disk controller 460 includes a disk interface 462. Disk controller 460 is connected to one or more disk drives via disk interface 462. Such disk drives include a hard disk drive (HDD) 464, and an optical disk drive (ODD) 466, and can include one or more disk drive as needed or desired. ODD 466 can include a Read/Write Compact Disk (R/W-CD), a Read/Write Digital Video Disk (R/W-DVD), a Read/Write mini Digital Video Disk (R/W mini-DVD, another type of optical disk drive, or any combination thereof. Additionally, disk controller 460 is connected to disk emulator 480. Disk emulator 480 permits a solid-state drive 484 to be coupled to information handling system 400 via an external interface 482. External interface 482 can include industry standard busses such as USB or IEEE 1394 (Firewire) or proprietary busses, or any combination thereof. Alternatively, solid-state drive 484 can be disposed within information handling system 400.

Network interface device 470 is connected to I/O interface 450. Network interface 470 and I/O interface 450 can be coupled via a unique channel, or via a bus that shares information among the I/O interface, the network interface, and other elements of information handling system 400. Other network interfaces (not illustrated) can also be used in addition to network interface 470 as needed or desired. Network interface 470 can be a network interface card (NIC) disposed within information handling system 400, on a main circuit board such as a baseboard, a motherboard, or any combination thereof, integrated onto another component such as chipset 420, in another suitable location, or any combination thereof. Network interface 470 includes a network channel 472 that provide interfaces between information handling system 400 and other devices (not illustrated) that are external to information handling system 400. Network interface 470 can also include additional network channels (not illustrated).

Information handling system 400 includes one or more application programs 432, and Basic Input/Output System and Firmware (BIOS/FW) code 434. BIOS/FW code 434 functions to initialize information handling system 400 on power up, to launch an operating system, and to manage input and output interactions between the operating system and the other elements of information handling system 400. In a particular embodiment, application programs 432 and BIOS/FW code 434 reside in memory 430, and include machine-executable code that is executed by processor 410 to perform various functions of information handling system 400. In another embodiment (not illustrated), application programs and BIOS/FW code reside in another storage medium of information handling system 400. For example, application programs and BIOS/FW code can reside in HDD 464, in a ROM (not illustrated) associated with information handling system 400, in an option-ROM (not illustrated) associated with various devices of information handling system 400, in storage system 490, in a storage system (not illustrated) associated with network channel 472, in another storage medium of information handling system 400, or a combination thereof. Application programs 432 and BIOS/FW code 434 can each be implemented as single programs, or as separate programs carrying out the various features as described herein.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality. The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An intrusion prevention network comprising:
a first intrusion prevention system having a first memory to store a first database, and a first processor operable to receive a file, to determine that the file does not correspond to a first entry of the first database, to send a request associated with the file to an intrusion prevention server responsive to determining that the file does not correspond to the first entry, to receive a reply from the intrusion prevention server, wherein the reply indicates that the file includes an exploit, and to provide an indication to a client system that the file includes the exploit responsive to the reply.

2. The intrusion prevention network of claim 1, further comprising:
an intrusion prevention server including a second memory to store a second database, and a second processor operable to receive the request, to determine if the file corresponds to a second entry of the second database, and to send the reply responsive to determining that the file corresponds to the second entry.

3. The intrusion prevention network of claim 2, wherein the second processor is further operable to send the second entry to the first intrusion prevention system.

4. The intrusion prevention network of claim 3, wherein the first processor is further operable to receive the second entry and to store the second entry in the first database.

5. The intrusion prevention network of claim 3, further comprising:
a second intrusion prevention system having a third memory to store a third database, and a third processor operable to receive the second entry from the intrusion prevention server and to store the second entry in the third database; and
wherein the second processor is further operable to send the second entry to the second intrusion prevention system.

6. The intrusion prevention network of claim 2, wherein the second processor is further operable to analyze the file to determine a third entry responsive to determining that the file does not correspond to the second entry, to store the third entry in the second database, and to send the third entry to the first intrusion prevention system.

7. The intrusion prevention network of claim 1, wherein the first processor is further operable to determine that the file corresponds to a second entry of the first database, and to block the file from being sent to the client system responsive to determining that the file corresponds to the second entry.

8. The intrusion prevention network of claim 7, wherein the second entry includes an indication that the file includes an exploit.

9. The intrusion prevention network of claim 1, wherein the first processor is further operable to determine that the file corresponds to a second entry of the first database, and to send the file to the client system responsive to determining that the file corresponds to the second entry.

10. The intrusion prevention network of claim 9, wherein the second entry includes an indication that the file is a safe file.

11. A method comprising:
receiving a file at a first intrusion prevention system;
determining that the file does not correspond to a first entry of a first database of the first intrusion prevention system;
sending a request associated with the file to an intrusion prevention server responsive to determining that the file does not correspond to the first entry;
receiving a reply from the intrusion prevention server, wherein the reply indicates that the file includes an exploit; and
providing an indication to a client system that the file includes the exploit responsive to the reply.

12. The method of claim 11, further comprising:
receiving at the intrusion prevention server the request;
determining if the file corresponds to a second entry of a second database of the intrusion prevention server; and
sending the reply to the first intrusion prevention system responsive to determining that the file corresponds to the second entry, wherein the reply includes the second entry.

13. The method of claim 12, further comprising:
receiving at the first intrusion prevention system the second entry; and
storing the second entry in the first database.

14. The method of claim 12, further comprising:
sending from the intrusion prevention server the second entry to a second intrusion prevention system; and
storing the second entry in a third database of the second intrusion prevention system.

15. The method of claim 12, further comprising:
analyzing the file at the intrusion prevention server to determine a third entry responsive to determining that the file does not correspond to the second entry;
storing the third entry in the second database; and
sending the third entry to the first intrusion prevention system.

16. The method of claim 11, further comprising:
determining that the file corresponds to a second entry of the first database; and
blocking the file from being sent to the client system responsive to determining that the file corresponds to the second entry.

17. The method of claim 11, further comprising:
determining that the file corresponds to a second entry of the first database; and
sending the file to the client system responsive to determining that the file corresponds to the second entry.

18. Machine-executable code for an information handling system, wherein the machine-executable code is embedded in a non-transitory storage medium and includes instructions for carrying out a method, the method comprising:
receiving a file at a first intrusion prevention system;
determining that the file does not correspond to a first entry of a first database of the first intrusion prevention system;
sending a request associated with the file to an intrusion prevention server responsive to determining that the file does not correspond to the first entry;
receiving a reply from the intrusion prevention server, wherein the reply indicates that the file includes an exploit; and
providing an indication to a client system that the file includes the exploit responsive to the reply.

19. The machine executable code of claim 18, the method further comprising:
receiving at the intrusion prevention server the request;
determining if the file corresponds to a second entry of a second database of the intrusion prevention server; and
sending the reply to the first intrusion prevention system responsive to determining that the file corresponds to the second entry, wherein the reply includes the second entry.

20. The machine executable code of claim 19, the method further comprising:
analyzing the file at the intrusion prevention server to determine a third entry responsive to determining that the file does not correspond to the second entry;
storing the third entry in the second database; and
sending the third entry to the first intrusion prevention system.
